(19) United States
(12) Patent Application Publication
(10) Pub. No.: US 2026/0297904 A1
(43) Pub. Date: Oct. 1, 2026

(54) WORKING MACHINE

(71) Applicant: HONDA MOTOR CO., LTD., Tokyo (JP)

(72) Inventors: Tatsuya Yamazaki, Wako-shi (JP); Yoshinori Masubuchi, Wako-shi (JP); Satoshi Hatori, Wako-shi (JP); Takuma Kimoto, Wako-shi (JP)

(21) Appl. No.: 19/570,217

(22) Filed: Mar. 18, 2026

(30) Foreign Application Priority Data
Mar. 27, 2025 (JP) 2025-054072

(51) Int. Cl. E02F 9/26; B60R 11/00; B60R 11/04

(52) U.S. Cl. CPC E02F 9/261; B60R 11/04; E02F 9/264; B60R 2011/004

(57) ABSTRACT

A working machine is equipped with vehicle wheels, a working unit, and a recognition unit that serves to recognize a surrounding vicinity of the working machine.

### CROSS-REFERENCE TO RELATED APPLICATIONS

This application is based upon and claims the benefit of priority from Japanese Patent Application No. 2025-054072 filed on Mar. 27, 2025, the contents of which are incorporated herein by reference.

### BACKGROUND OF THE INVENTION

### Field of the Invention

The present invention relates to a working machine.

Description of the Related Art

In JP 2016-156223 A, a snow removal machine is disclosed that carries out a snow removal operation based on the operation of operating handlebars by an operator.

### SUMMARY OF THE INVENTION

There is a long-awaited need for a technology that is capable of enabling the situation around the surrounding vicinity of a working machine to be easily recognized.

The present invention has the object of solving the aforementioned problem.

An aspect of the present disclosure is characterized by a working machine, comprising vehicle wheels, a working unit, and a recognition unit configured to recognize a surrounding vicinity of the working machine.

According to the present disclosure, the situation around the surrounding vicinity of a working machine can be easily recognized.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a left side view of a working machine according to one embodiment;

FIG. 2 is a plan view of the working machine shown in FIG. 1;

FIG. 3 is a rear view of the working machine shown in FIG. 1;

FIG. 4 is a bottom view of the working machine shown in FIG. 1;

FIG. 5 is a perspective view of a frame device shown in FIG. 1;

FIG. 6 is a diagram showing a recognition range of a first recognition unit;

FIG. 7 is a diagram showing a recognition range of a second recognition unit;

FIG. 8 is a diagram showing the recognition range of the first recognition unit; and

FIG. 9 is a diagram showing the recognition range of the second recognition unit.

### DETAILED DESCRIPTION OF THE INVENTION

In recent years, in order to easily recognize the situation of a surrounding vicinity of a working machine (for example, a working region of a working unit), it has become desirable to optimally dispose a recognition unit (a sensor) on the working machine.

According to the present disclosure, a working machine is provided which, together with being capable of easily recognizing the situation of the surrounding vicinity of the working machine, is capable of optimizing the manner in which the recognition unit is disposed.

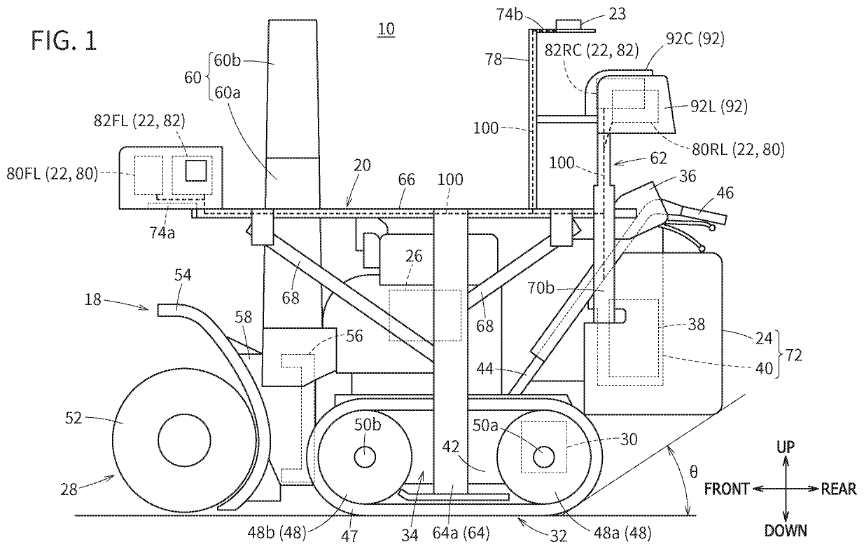

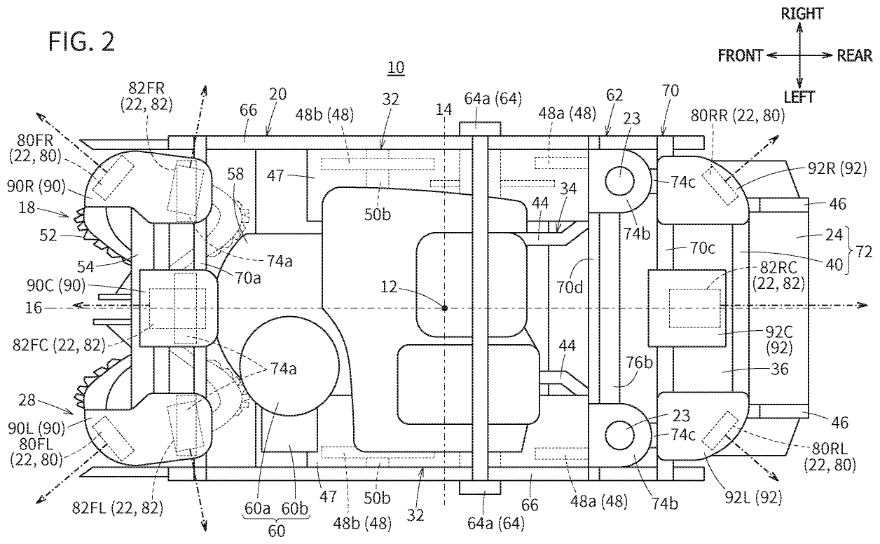

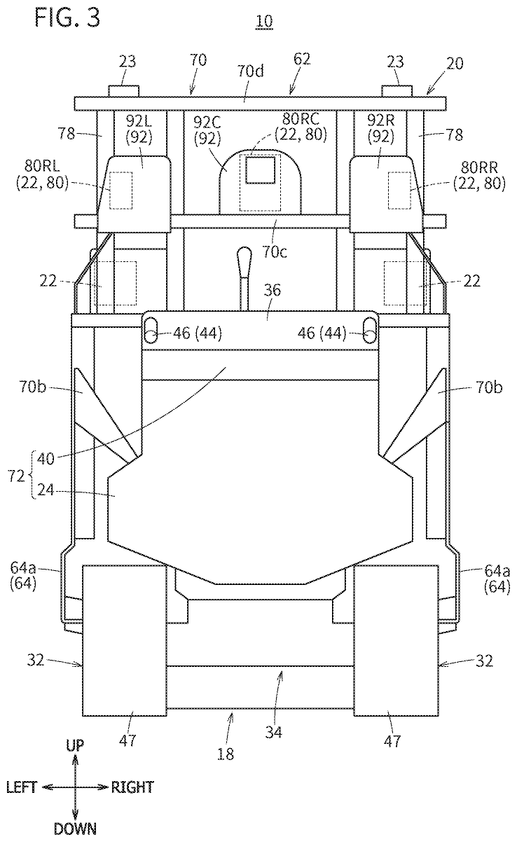

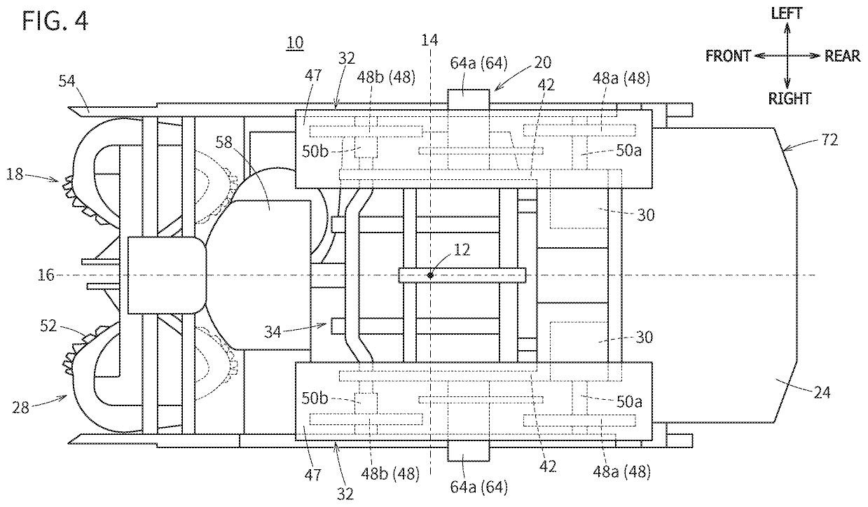

A description will be given with reference to FIG. 1 to FIG. 9 concerning a working machine 10 according to one embodiment. FIG. 1 is a left side view of the working machine 10 according to the one embodiment. FIG. 2 is a plan view of the working machine 10. FIG. 3 is a rear view of the working machine 10. FIG. 4 is a bottom view of the working machine 10. In the following description, a direction in which the working machine 10 moves frontward is referred to as a frontward direction, a direction in which the working machine moves rearward is referred to as a rearward direction, and a front-rear direction, a left-right direction (a vehicle widthwise direction), and an up-down direction of the working machine 10 are described. The front-rear direction is a direction in which the working machine 10 moves frontward or moves rearward (a direction in which the working machine 10 moves). The front-rear direction and the left-right direction are horizontal directions of the working machine 10. The up-down direction is a direction (a vertical direction) that is perpendicular to the horizontal direction of the working machine 10.

As shown in FIG. 2, as viewed in plan, a center in a front-rear direction and a left-right direction of the working machine 10 is defined as a center point (a front-rear center, a left-right center) 12. A center line that passes through the center point 12 of the working machine 10, and further, extends in the left-right direction is defined as a front-rear center line (a front-rear center) 14. Accordingly, a side (a front side) that is more frontward than the front-rear center line 14 in the working machine 10 is a front side portion (a front part) of the working machine 10. A side (a rear side) that is more rearward than the front-rear center line 14 in the working machine 10 is a rear side portion (a rear part) of the working machine 10. A center line that passes through the center point 12 of the working machine 10, and further, extends in the front-rear direction is defined as a left-right center line (a left-right center) 16. Accordingly, a side (a left side) that is more leftward than the left-right center line 16 in the working machine 10 is a left side portion (a left part) of the working machine 10. A side (a right side) that is more rightward than the left-right center line 16 in the working machine 10 is a right side portion (a right part) of the working machine 10.

As shown in FIG. 1 to FIG. 4, the working machine 10 is a working machine that is capable of carrying out at least one from among autonomous traveling and autonomous operation. The working machine 10 is a snow removal machine. The snow removal machine is a working machine that is used to carry out the removal of snow. The working machine 10, although not necessarily limited to this feature, is a snow removal machine that can be pushed from behind by a user to carry out the snow removal operation. In the following description, a description will be given concerning a case in which the working machine 10 is a snow removal machine.

The working machine 10 includes a working machine main body 18, a frame device (a mounting frame, an electronic device support structure) 20, surrounding vicinity recognition units (recognition units, an electronic devices) 22, position recognition units (recognition units, electronic devices) 23, and a frame side control unit (an electronic device, a control unit) 24.

The working machine main body 18 is equipped with a configuration that is similar to that of the snow removal machine described in JP 2016-156223 A. More specifically, the working machine main body 18 is capable of carrying out a snow removal operation without being equipped with the frame device 20, the surrounding vicinity recognition units 22, the position recognition units 23, and the frame side control unit 24.

In detail, the working machine main body 18 includes an engine 26, a working unit 28, a pair of left and right electric motors 30, a pair of left and right traveling units 32, a vehicle body frame 34, an operating unit 36, a battery 38, and a main body side control unit (a control unit) 40.

The vehicle body frame 34 constitutes a machine body of the working machine main body 18. The vehicle body frame 34 is equipped with a pair of left and right crawler frames (first partial frames) 42, and a pair of left and right operating handlebars (second partial frames) 44.

The pair of left and right crawler frames 42 are disposed at both end parts of the vehicle body frame 34 in the vehicle widthwise direction (the left-right direction). As shown in FIG. 4, the pair of left and right crawler frames 42 sandwich the left-right center line 16, and are disposed on the vehicle body frame 34 with a space therebetween in the vehicle widthwise direction. The crawler frames 42, while straddling over the front-rear center line 14, extend in the front-rear direction.

As shown in FIG. 1 to FIG. 3, the pair of left and right operating handlebars 44 are provided on a rear part of the vehicle body frame 34. The pair of left and right operating handlebars 44 are positioned more rearward than the front-rear center line 14. The pair of left and right operating handlebars 44 sandwich the left-right center line 16, and are disposed on a rear part of the vehicle body frame 34 with a space therebetween in the vehicle widthwise direction. The operating handlebars 44 extend rearward and upward. Grips 46 are mounted on distal end parts of the operating handlebars 44. The user, by grasping the grips 46, is capable of operating the operating handlebars 44. In the present embodiment, the distal end parts (the grips 46) of the operating handlebars 44 may be included in the operating unit 36. The operating handlebars 44 and the frame side control unit 24, from among the constituent elements of the working machine 10, project out the farthest to the rear. The distal end parts of the operating handlebars 44 (the rear ends of the grips 46) and the rear end of the frame side control unit 24 make up a rear end of the working machine 10.

The engine 26 is supported on an upper part of the vehicle body frame 34. The engine 26 can be positioned in close proximity to the center point 12. The engine 26 is a motive power source in order to drive the working unit 28.

As shown in FIG. 4, the pair of left and right electric motors 30 are positioned more rearward than the front-rear center line 14. The pair of left and right electric motors 30 sandwich the left-right center line 16, and are supported on a rear part of the vehicle body frame 34 with a space therebetween in the vehicle widthwise direction. As shown in FIG. 1, the pair of left and right electric motors 30 are positioned downward of the pair of left and right operating handlebars 44.

As shown in FIG. 1 to FIG. 4, the pair of left and right traveling units 32 are disposed on both end parts in the vehicle widthwise direction of the vehicle body frame 34. The pair of left and right traveling units 32 sandwich the left-right center line 16, and are disposed on both end parts of the vehicle body frame 34 with a space therebetween in the vehicle widthwise direction. The traveling units 32, while straddling over the front-rear center line 14, extend in the front-rear direction.

The traveling units 32 are equipped with crawler belts 47 and vehicle wheels 48. The vehicle wheels 48 include driving wheels 48a and rolling wheels 48b. Drive shaft portions 50a are provided on rear parts of the crawler frames 42. Rolling shaft portions 50b are provided on front parts of the crawler frames 42.

The drive shaft portions 50a are positioned more rearward than the front-rear center line 14. The drive shaft portions 50a extend toward outer sides in the vehicle widthwise direction from the rear parts of the crawler frames 42. The driving wheels 48a are rotatably supported by the drive shaft portions 50a. The rolling shaft portions 50b are positioned more frontward than the front-rear center line 14.

The rolling shaft portions 50b extend toward outer sides in the vehicle widthwise direction from the front parts of the crawler frames 42. The rolling wheels 48b are rotatably supported by the rolling shaft portions 50b. Therefore, in the traveling units 32, the rolling wheels 48b and the driving wheels 48a sandwich the front-rear center line 14, and are disposed with a space therebetween in the front-rear direction.

The crawler belts 47 are wound around the driving wheels 48a and the rolling wheels 48b, along the front-rear direction, in a manner so as to straddle over the front-rear center line 14.

The left side electric motor 30 drives the left side traveling unit 32. The right side electric motor 30 drives the right side traveling unit 32. Specifically, by the electric motors 30 being driven, the driving wheels 48a are rotated. By the driving wheels 48a being rotated, the crawler belts 47 are driven. By the crawler belts 47 being driven, the working machine main body 18 can be made to move forward or move rearward.

The working unit 28 is positioned more frontward than the front-rear center line 14. The working unit 28, while straddling over the left-right center line 16, is supported on a front portion of the vehicle body frame 34. The working unit 28 includes an auger 52, an auger housing 54, a blower 56, a blower case 58, and a snow throwing unit 60.

The blower case 58, while straddling over the left-right center line 16, is connected to the front portion of the vehicle body frame 34. The blower 56 is provided in the interior of the blower case 58.

The auger housing 54 is connected to a front part of the blower case 58. The auger housing 54, while straddling over the left-right center line 16, extends in the vehicle widthwise direction. The auger housing 54 is open to the front. Among each of the constituent elements of the working unit 28, the auger housing 54 projects out the farthest in the vehicle widthwise direction. Therefore, both end parts in the vehicle widthwise direction of the auger housing 54 are both end parts in the vehicle widthwise direction of the working unit 28.

The auger 52 is disposed in the auger housing 54. A portion of the auger 52 projects out frontward from the auger housing 54. Among each of the constituent elements of the working machine 10, the auger 52 projects out the farthest in the frontward direction. Therefore, the front end part of the auger 52, together with being a front end part of the working machine 10, is also a front end part of the working unit 28.

The snow throwing unit 60 is disposed on an upper part of the blower case 58. The snow throwing unit 60 includes a chute 60a, and a chute guide 60b.

A base end part of the chute 60a is positioned more leftward than the left-right center line 16 above the upper part of the blower case 58, although the present disclosure is not necessarily limited to this feature. The chute 60a extends upward from the upper part of the blower case 58. The chute 60a, on the upper part of the blower case 58, is rotatable about a vertical axis.

The chute guide 60b is mounted on an upper end part of the chute 60a. The chute guide 60b is capable of swinging in the up-down direction with respect to the chute 60a. The chute guide 60b, among the constituent elements of the working unit 28, is positioned at the uppermost location. The chute guide 60b is an upper end of the working unit 28. Further, the chute guide 60b, by being swung upward, is capable of projecting out more upward than the other constituent elements of the working machine 10. The upper end of the chute guide 60b can serve as the upper end of the working unit 28. Moreover, it should be noted that the chute guide 60b, since it is capable of being swung in the up-down direction, does not necessarily always project out more upward than the other constituent elements of the working machine 10. In the case that the chute guide 60b is swung in the downward direction, and the chute guide 60b is positioned more downward than the position recognition units 23, the position recognition units 23 can serve as the upper end of the working machine 10.

The motive power of the engine 26 is transmitted, via a non-illustrated motive power transmission mechanism, to the auger 52 and the blower 56. The auger 52, by being driven by the motive power that is transmitted from the engine 26, gathers up snow that exists within the operating range of the auger 52. Moreover, the operating range of the auger 52 is a region on an inner side of the auger housing 54, and further, that exists between the front end and the rear end of the auger 52. The snow that is collected by the auger 52 is delivered via the blower 56 to the snow throwing unit 60. The snow throwing unit 60 hurls (throws) far away the snow that is collected by the auger 52. The chute 60a, by being rotated about a vertical axis, can adjust the direction in which the snow is thrown (the orientation of the snow throwing). Further, by swinging the chute guide 60b in the up-down direction, it is possible to adjust the snow throwing angle. Moreover, it should be noted that the operating range of the snow throwing unit 60 includes the range of rotation of the chute 60a, and the swinging range of the chute guide 60b.

The operating unit 36, the main body side control unit 40, and the battery 38 are positioned more rearward than the front-rear center line 14. The operating unit 36, the main body side control unit 40, and the battery 38 are disposed between the pair of left and right operating handlebars 44. The operating unit 36, the main body side control unit 40, and the battery 38 are positioned, in the up-down direction, between the grips 46 and the electric motors 30.

The operating unit 36, together with being disposed so as to straddle over the left-right center line 16, is positioned in a manner so as to overlap the grips 46 in the up-down direction. The operating unit 36 is mounted on the pair of left and right operating handlebars 44. The user, by operating the operating unit 36, is capable of causing the working machine main body 18 to move forward, to move rearward, to turn, or to stop. Further, the user, by operating the operating unit 36, can cause the engine 26 to be started or to be stopped.

The main body side control unit 40 is positioned downward of the operating unit 36, in a manner so as to straddle over the left-right center line 16. The main body side control unit 40 is supported by the pair of left and right operating handlebars 44. The battery 38 is, downward of the operating unit 36, supported integrally with the main body side control unit 40 by the pair of left and right operating handlebars 44. The main body side control unit 40 is driven by the electrical power that is supplied from the battery 38. The main body side control unit 40 is equipped with a non-illustrated internal memory. The main body side control unit 40, by reading out and executing programs that are stored in the memory, is capable of executing various control processes.

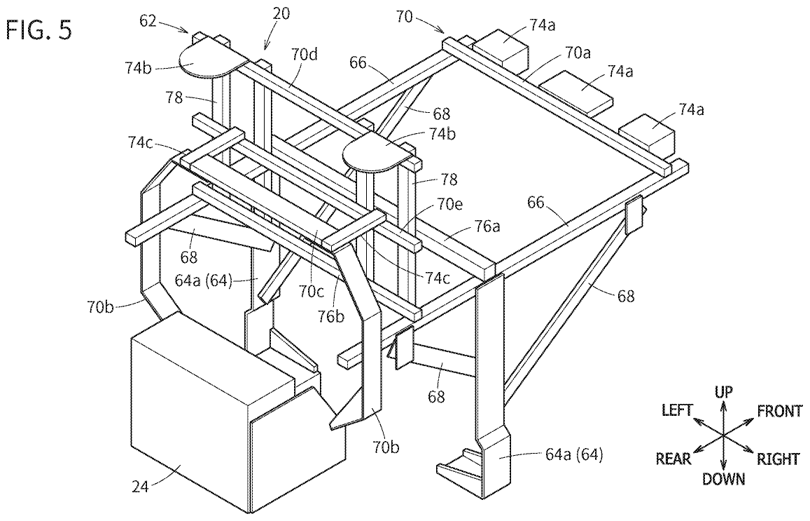

The frame device 20 is mounted on the vehicle body frame 34. The frame device 20 is capable of being attached and detached with respect to the vehicle body frame 34. As noted previously, since the working machine main body 18 is capable of independently carrying out the snow removal operation, the frame device 20 is mounted in the form of an after-market attachment on the working machine main body 18. As shown in FIG. 5, the frame device 20 includes a support portion 62 and a connecting portion 64.

As shown in FIG. 4, the connecting portion 64 is connected to the vehicle body frame 34. The connecting portion 64 is capable of being attached and detached with respect to the vehicle body frame 34. The connecting portion 64 is mounted on the vehicle body frame 34 in a manner so that the relative position thereof with respect to the vehicle body frame 34 is capable of being adjusted. Further, the connecting portion 64 is mounted on a portion of the vehicle body frame 34 where the vibrations that are generated at a time when the working machine 10 is in operation are relatively small.

As shown in FIG. 5, the connecting portion 64 includes a pair of left and right connecting frames 64a. The connecting frames 64a are L-shaped frames. As shown in FIG. 3, the connecting frames 64a extend in the up-down direction, on a more outer side in the vehicle widthwise direction than the crawler belts 47. As shown in FIG. 3 and FIG. 4, the lower end parts of the connecting frames 64a, at a location between the crawler frames 42 and the lower parts of the crawler belts 47, are bent toward inner sides in the vehicle widthwise direction. The lower end parts of the connecting frames 64a are connected to the crawler frames 42. Specifically, the lower end parts of the connecting frames 64a are connected at locations of the crawler frames 42 between the rolling wheels 48b and the driving wheels 48a. As shown in FIG. 5, the upper end parts of the connecting frames 64a are connected to front-rear connecting frames 66 that extend in the front-rear direction.

The connecting frames 64a are detachable with respect to the crawler frames 42 (refer to FIG. 1). Further, the connecting frames 64a, for example, are capable of being adjusted in position in the up-down direction with respect to the crawler frames 42. The crawler frames 42 are mounted on portions of the vehicle body frame 34 where the vibrations that are generated at a time when the working machine 10 is in operation are relatively small.

The connecting frames 64a and the front-rear connecting frames 66 are connected via a plurality of reinforcing frames 68. One end part of each of the reinforcing frames 68 is connected to an intermediate portion of the connecting frames 64a between the upper end part and the lower end part. The other end part of each of the reinforcing frames 68 is connected to a front side portion or rear side portion of each of the front-rear connecting frames 66.

As shown in FIG. 2 to FIG. 4, the pair of left and right connecting frames 64a, among the constituent elements of the working machine 10, project out the farthest toward the outer side in the vehicle widthwise direction. Therefore, the outer end parts in the vehicle widthwise direction of the pair of left and right connecting frames 64a are both end parts in the vehicle widthwise direction of the working machine 10.

The support portion 62 is capable of supporting various electronic devices, which will be described later. As shown in FIG. 5, the support portion 62 includes a plurality of support frames 70. The plurality of support frames 70 include a front side support frame 70a, a pair of left and right rear side support frames 70b, a first left and right support frame 70c, a second left and right support frame 70d, and a third left and right support frame 70e. As noted previously, the electronic device includes a plurality of the surrounding vicinity recognition units 22 (see FIGS. 1 to 3), a plurality of the position recognition units 23, and the frame side control unit 24. These electronic devices, by the frame device 20 being mounted on the working machine main body 18, are provided in the form of after-market attachments on the working machine main body 18.

As shown in FIG. 1 to FIG. 5, the frame side control unit 24 is equipped with non-illustrated memory. The frame side control unit 24, by reading out and executing programs that are stored in the memory, is capable of executing various control processes. The frame side control unit 24 is electrically connected, via non-illustrated wiring, to the main body side control unit 40. By the frame side control unit 24 and the main body side control unit 40, a control device (a control unit) 72 that controls each of respective parts of the working machine 10 is constituted. The control device 72 is capable of controlling each of the respective parts of the working machine 10. In this case, the frame side control unit 24 and the main body side control unit 40 may work together in cooperation, and thereby may control each of the respective parts of the working machine 10. Alternatively, from among the frame side control unit 24 and the main body side control unit 40, at least one thereof may control each of the respective parts of the working machine 10. The working machine 10, by being equipped with the frame side control unit 24, can perform autonomous travel and autonomous work.

As shown in FIG. 1, front end parts of the pair of left and right front-rear connecting frames 66 are positioned upward of the auger housing 54. Specifically, as shown in FIG. 1 and FIG. 2, the front end parts of the pair of left and right front-rear connecting frames 66 are positioned upward of both end parts in the vehicle widthwise direction of the auger housing 54. The front end parts of the front-rear connecting frames 66 are positioned in a manner so as to avoid the operating range of the working unit 28. Moreover, the operating range of the working unit 28 includes the operating range of the auger 52, the operating range of the snow throwing unit 60, and the operating range of the blower 56.

As shown in FIG. 5, the front end parts of the pair of left and right front-rear connecting frames 66 are connected via the front side support frame 70a. As shown in FIG. 2, the front side support frame 70a, while straddling over the left-right center line 16, extends in the left-right direction. A left end part of the front side support frame 70a is connected to a front end part of the left side front-rear connecting frame 66. A right end part of the front side support frame 70a is connected to a front end part of the right side front-rear connecting frame 66.

As shown in FIG. 5, three of the brackets 74a are mounted on the front side support frame 70a with a space therebetween in the left-right direction. As shown in FIG. 1 and FIG. 2, the brackets 74a, together with being positioned more rearward than the front end part of the working unit 28, are positioned more frontward than the rear end of the working machine 10. Further, the brackets 74a are positioned more downward than the upper end of the working machine 10, and further, are positioned more on an inner side in the vehicle widthwise direction than both end parts in the vehicle widthwise direction of the working unit 28. Furthermore, the brackets 74a are positioned upward of the auger housing 54. Further, the brackets 74a are disposed in a manner so as not to overlap with the operating range of the working unit 28.

A central bracket 74a is positioned on the left-right center line 16. The left side bracket 74a is positioned on the left side of the front side support frame 70a. The left side bracket 74a, as viewed in plan, is positioned more on an inner side in the vehicle widthwise direction than a left end part of the auger housing 54. The right side bracket 74a is positioned on the right side of the front side support frame 70a. The right side bracket 74a, as viewed in plan, is positioned more on an inner side in the vehicle widthwise direction than a right end part of the auger housing 54.

The rear end parts of the pair of left and right front-rear connecting frames 66 are positioned rearward of the traveling units 32. Specifically, the rear end parts of the front-rear connecting frames 66 are positioned upward of the traveling units 32, on more outer sides in the vehicle widthwise direction than the operating handlebars 44. As shown in FIG. 5, the rear side support frames 70b are connected to the rear end parts of the front-rear connecting frames 66. The rear side support frames 70b extend in the up-down direction. Intermediate portions of the rear side support frames 70b are connected to the rear end parts of the front-rear connecting frames 66. Lower end parts of the pair of left and right rear side support frames 70b support the frame side control unit 24 in the vehicle widthwise direction. As shown in FIG. 3 and FIG. 5, the pair of left and right rear side support frames 70b support the frame side control unit 24, in a manner so that the frame side control unit 24 is positioned between the pair of left and right operating handlebars 44.

As shown in FIG. 1, the upper ends of the pair of left and right rear side support frames 70b are positioned more upward than the operating handlebars 44, and further, more downward than the upper end of the working machine 10. As shown in FIG. 5, the upper ends of the pair of left and right rear side support frames 70b are connected via the first left and right support frame 70c that extends in the left-right direction.

The pair of left and right front-rear connecting frames 66 are connected via a first left-right connecting frame 76a and a second left-right connecting frame 76b. The first left-right connecting frame 76a and the second left-right connecting frame 76b are spaced apart in the front-rear direction, and serve to connect the pair of left and right front-rear connecting frames 66 in the left-right direction. The first left-right connecting frame 76a connects in the left-right direction the connecting locations of at which the pair of left and right front-rear connecting frames 66 is connected with the connecting frames 64a. The second left-right connecting frame 76b is positioned between the first left-right connecting frame 76a and the pair of left and right rear side support frames 70b. The second left-right connecting frame 76b connects in the left-right direction locations of the pair of left and right front-rear connecting frames 66 between the first left-right connecting frame 76a and the rear side support frames 70b. A plurality of up-down connecting frames 78 are connected to the second left-right connecting frame 76b.

The plurality of up-down connecting frames 78 are connected to the second left-right connecting frame 76b with a space therebetween in the left-right direction. Lower end parts of the plurality of up-down connecting frames 78 are connected to the second left-right connecting frame 76b. The plurality of up-down connecting frames 78 extend upward from the second left-right connecting frame 76b.

The second left and right support frame 70d and the third left and right support frame 70e are connected to the plurality of up-down connecting frames 78. The second left and right support frame 70d and the third left and right support frame 70e extend in the left-right direction with a space therebetween in the up-down direction. The second left and right support frame 70d connects in the left-right direction the upper end parts of the plurality of up-down connecting frames 78. The third left and right support frame 70e connects in the left-right direction the intermediate portions of the plurality of up-down connecting frames 78 between the upper end part and the lower end part. The third left and right support frame 70e is positioned at approximately the same height as the first left and right support frame 70c.

As shown in FIG. 2, two plate shaped brackets 74b sandwich the left-right center line 16, and are mounted on the second left and right support frame 70d with a space therebetween in the left-right direction. As shown in FIG. 1 and FIG. 2, the brackets 74b, together with being positioned more rearward than the front end part of the working unit 28, are positioned more frontward than the rear end of the working machine 10. Further, the brackets 74b, together with being positioned more downward than the upper end of the working machine 10, are positioned more on an inner side in the vehicle widthwise direction than both end parts in the vehicle widthwise direction of the working unit 28. Furthermore, the brackets 74b are positioned more upward than the brackets 74a that are disposed on the front side support frame 70a. As shown in FIG. 5, the left side bracket 74b is disposed on the left end part of the second left and right support frame 70d. The right side bracket 74b is disposed on the right end part of the second left and right support frame 70d.

Two rod shaped brackets 74c are suspended in the front-rear direction, between the pair of left and right rear side support frames 70b and the third left and right support frame 70e. The two of the brackets 74c sandwich the left-right center line 16 (refer to FIG. 2), and span across the pair of left and right rear side support frames 70b and the third left and right support frame 70e with a space therebetween in the left-right direction. The brackets 74c, together with being positioned more rearward than the front end part of the working unit 28, are positioned more frontward than the rear end of the working machine 10. Further, the brackets 74c, together with being positioned more downward than the upper end of the working machine 10, are positioned more on an inner side in the vehicle widthwise direction than both end parts in the vehicle widthwise direction of the working unit 28. Furthermore, the brackets 74c, together with being positioned more upward than the three of the brackets 74a that are disposed on the front side support frame 70a, are positioned more downward than the two of the brackets 74b that are disposed on the second left and right support frame 70d. The left side bracket 74c connects the upper end part of the rear side support frame 70b on the left side to the left side portion of the third left and right support frame 70e. The right side bracket 74c connects the upper end part of the rear side support frame 70b on the right side to the right side portion of the third left and right support frame 70e.

Moreover, it should be noted that the electronic device described above is not necessarily limited to being directly supported by the support portion 62. The aforementioned electronic device may be indirectly supported, via a non-illustrated joint, by the support portion 62. In other words, in the present embodiment, supporting of the electronic device by the support portion 62 includes both a case in which the electronic device is supported by directly connecting the electronic device to the support portion 62, and a case in which the electronic device is supported by indirectly connecting the electronic device to the support portion 62.

As shown in FIG. 1 to FIG. 3, the working machine 10 is equipped with a plurality of recognition units. The plurality of recognition units are a plurality of the surrounding vicinity recognition units (recognition units) 22 that recognize the surrounding vicinity of the working machine 10, and a plurality of the position recognition units 23 that recognize the current position of the working machine 10.

The plurality of surrounding vicinity recognition units 22 are disposed at least one from among frontward with respect to the front-rear center line 14, or rearward with respect to the front-rear center line 14. More specifically, the plurality of surrounding vicinity recognition units 22 include a frontward recognition unit that is positioned more frontward than the front-rear center line 14, and a rearward recognition unit that is positioned more rearward than the front-rear center line 14. The frontward recognition unit is positioned more downward than the upper end of the working machine 10. The frontward recognition unit, together with overlapping with the working unit 28 as viewed in plan, does not overlap with the operating range of the working unit 28 as viewed from the side. Further, the number of the rearward recognition units is less than the number of the frontward recognition units. The rearward recognition unit is disposed more upward than the frontward recognition unit. The rearward recognition unit is disposed more downward than the upper end of the working machine 10, and further, upward of the control device 72.

Further, the surrounding vicinity recognition units 22 are disposed more on the inner side in the vehicle widthwise direction than both ends in the vehicle widthwise direction of the working machine 10. Specifically, the surrounding vicinity recognition units 22 are disposed more on the inner side in the vehicle widthwise direction than both ends in the vehicle widthwise direction of the working unit 28. More specifically, the surrounding vicinity recognition units 22 are disposed in closer vicinity to the left-right center line 16 than both ends in the vehicle widthwise direction of the working unit 28.

Furthermore, the surrounding vicinity recognition units 22 include left side recognition units that are disposed more on the left side than the left-right center line 16, and right side recognition units that are disposed more on the right side than the left-right center line 16. The left side recognition units include a front left recognition unit that is disposed more frontward than the front-rear center line 14, and a rear left recognition unit that is disposed more rearward than the front-rear center line 14. The right side recognition units include a front right recognition unit that is disposed more frontward than the front-rear center line 14, and a rear right recognition unit that is disposed more rearward than the front-rear center line 14. The front left recognition unit and the front right recognition unit are disposed more rearward than a front end part of the working unit 28, overlap with the working unit 28 as viewed in plan, and further, do not overlap with the operating range of the working unit 28 as viewed from the side. The rear left recognition unit and the rear right recognition unit are disposed more downward than the upper end of the working machine 10, and further, upward of the control device 72.

The surrounding vicinity recognition units 22 include a first recognition unit 80 that recognizes the surrounding vicinity of the working machine 10 using a first recognition mechanism, and a second recognition unit 82 that recognizes the surrounding vicinity of the working machine 10 using a second recognition mechanism that differs from the first recognition mechanism. The second recognition unit 82 has a wider recognition range than the first recognition unit 80, or has a higher distance measurement capacity than the first recognition unit 80, or alternatively, has a wider recognition range and a higher distance measurement capacity than the first recognition unit 80.

Each of the frontward recognition unit and the rearward recognition unit includes two types of recognition units with different recognition mechanisms. Each of the frontward recognition unit and the rearward recognition unit includes the first recognition unit 80 and the second recognition unit 82.

The first recognition unit 80 is a radar sensor. The first recognition unit 80 is a distance measurement sensor that serves to detect the surrounding vicinity of the working machine 10. The first recognition unit 80, by irradiating radio waves such as millimeter waves or the like around the vicinity of the working machine 10, and by receiving reflected waves of the radio waves from a working target object and surrounding objects existing around the vicinity of the working machine 10 (the first recognition mechanism), recognizes the distance and the direction to the working target object and the surrounding objects, as well as the shapes of the working target object and the surrounding objects. Moreover, the working target object is an object that serves as a target of the work performed by the working machine 10. Specifically, the working target object is snow. Further, the surrounding objects, for example, are obstacles that may hinder or obstruct the work of the working machine 10.

The second recognition unit 82 is a LiDAR sensor. The second recognition unit 82 is a distance measurement sensor that detects the surrounding vicinity of the working machine 10, by using a recognition mechanism that differs from that of the first recognition unit 80. The second recognition unit 82, by irradiating laser light around the vicinity of the working machine 10, and by receiving reflected light of the laser light from the working target object and surrounding objects existing around the vicinity of the working machine 10 (the second recognition mechanism), recognizes the distance and the direction to the working target object and the surrounding objects, as well as the shapes of the working target object and the surrounding objects.

Specifically, the frontward recognition unit includes two first recognition units 80 and three second recognition units 82. The two first recognition units 80 and the three second recognition units 82 are disposed on a front part of the working machine 10.

The two first recognition units 80 are disposed respectively on the left side and the right side with respect to the left-right center line 16. From among the three second recognition units 82, one of the second recognition units 82 is disposed on the left-right center line 16. The remaining two of the second recognition units 82 are disposed respectively on the left side and the right side with respect to the left-right center line 16.

More specifically, three front side accommodation units 90 are provided on the front side of the working machine 10. Three rear side accommodation units 92 are provided on the rear side of the working machine 10. Each of the front side accommodation units 90 and the rear side accommodation units 92 accommodates therein at least one of the first recognition units 80 and the second recognition units 82. The first recognition units 80 and the second recognition units 82, by being accommodated respectively in the front side accommodation units 90 and the rear side accommodation units 92, are protected from the exterior.

The three front side accommodation units 90 are disposed on the three brackets 74a (refer to FIG. 5). Therefore, the three front side accommodation units 90 are positioned more rearward than the front end part of the working machine 10, and further, more downward than the upper end of the working machine 10. Further, the three front side accommodation units 90, together with overlapping with the working unit 28 as viewed in plan, do not overlap with the operating range of the working unit 28 as viewed from the side. The three front side accommodation units 90, as viewed in plan, are positioned more on an inner side in the vehicle widthwise direction than both end parts in the vehicle widthwise direction of the working unit 28.

From among the three front side accommodation units 90, a front central accommodation unit 90C is disposed on the central bracket 74a that passes through the left-right center line 16. One of the second recognition units 82 is accommodated in the front central accommodation unit 90C. The second recognition unit 82 that is accommodated in the front central accommodation unit 90C is a front center second recognition unit (frontward recognition unit) 82FC. A sensor surface of the front center second recognition unit 82FC faces frontward. The front center second recognition unit 82FC recognizes the distance and the direction to the working target object and the surrounding objects that are positioned frontward of the working machine 10.

From among the three front side accommodation units 90, a front left accommodation unit 90L is disposed on a left side bracket 74a. One of the first recognition units 80 and one of the second recognition units 82 are accommodated in the front left accommodation unit 90L. The first recognition unit 80 that is accommodated in the front left accommodation unit 90L is a front left first recognition unit (frontward recognition unit, left recognition unit, front left recognition unit) 80FL. The second recognition unit 82 that is accommodated in the front left accommodation unit 90L is a front left second recognition unit (frontward recognition unit, left recognition unit, front left recognition unit) 82FL. In the interior of the front left accommodation unit 90L, the front left first recognition unit 80FL and the front left second recognition unit 82FL are disposed alongside one another in the front-rear direction. The front left first recognition unit 80FL is disposed more frontward than the front left second recognition unit 82FL.

The front left first recognition unit 80FL is accommodated in the front left accommodation unit 90L, in a manner so as to recognize an area diagonally frontward to the left from the working machine 10. More specifically, the front left first recognition unit 80FL is positioned in the interior of the front left accommodation unit 90L, in a manner so that a sensor surface of the front left first recognition unit 80FL faces diagonally frontward to the left (in a leftward direction and a frontward direction) from the working machine 10. The front left first recognition unit 80FL recognizes the distance and the direction to the working target object and the surrounding objects that are positioned diagonally frontward to the left from the working machine 10.

The front left second recognition unit 82FL is accommodated in the front left accommodation unit 90L, in a manner so as to recognize an area on a left side and diagonally rearward to the left from the working machine 10. More specifically, the front left second recognition unit 82FL is positioned in the interior of the front left accommodation unit 90L, in a manner so that a sensor surface of the front left second recognition unit 82FL faces diagonally rearward to the left (in a leftward direction and a rearward direction) from the working machine 10. The front left second recognition unit 82FL recognizes the distance and the direction to the working target object and the surrounding objects that are positioned on the left side and diagonally rearward to the left from the working machine 10.

From among the three front side accommodation units 90, a front right accommodation unit 90R is disposed on a right side bracket 74a. The front right accommodation unit 90R has a shape obtained by having left-right inverted the front left accommodation unit 90L. One of the first recognition units 80 and one of the second recognition units 82 are accommodated in the front right accommodation unit 90R. The first recognition unit 80 that is accommodated in the front right accommodation unit 90R is a front right first recognition unit (frontward recognition unit, right recognition unit, front right recognition unit) 80FR. The second recognition unit 82 that is accommodated in the front right accommodation unit 90R is a front right second recognition unit (frontward recognition unit, right recognition unit, front right recognition unit) 82FR. In the interior of the front right accommodation unit 90R, the front right first recognition unit 80FR and the front right second recognition unit 82FR are disposed alongside one another in the front-rear direction. The front right first recognition unit 80FR is disposed more frontward than the front right second recognition unit 82FR.

The front right first recognition unit 80FR is accommodated in the front right accommodation unit 90R, in a manner so as to recognize an area diagonally frontward to the right from the working machine 10. More specifically, the front right first recognition unit 80FR is positioned in the interior of the front right accommodation unit 90R, in a manner so that a sensor surface of the front right first recognition unit 80FR faces diagonally frontward to the right (in a rightward direction and a frontward direction) from the working machine 10. The front right first recognition unit 80FR recognizes the distance and the direction to the working target object and the surrounding objects that are positioned diagonally frontward to the right from the working machine 10.

The front right second recognition unit 82FR is accommodated in the front right accommodation unit 90R, in a manner so as to recognize an area on a right side and diagonally rearward to the right from the working machine 10. More specifically, the front right second recognition unit 82FR is positioned in the interior of the front right accommodation unit 90R, in a manner so that a sensor surface of the front right second recognition unit 82FR faces diagonally rearward to the right (in a rightward direction and a rearward direction) from the working machine 10. The front right second recognition unit 82FR recognizes the distance and the direction to the working target object and the surrounding objects that are positioned on the right side diagonally rearward to the right from the working machine 10.

The three rear side accommodation units 92 are disposed on the brackets 74c or on the first left and right support frame 70c (refer to FIG. 5). Therefore, the three rear side accommodation units 92 are positioned more frontward than the rear end of the working machine 10, and further, more downward than the upper end of the working machine 10. Further, the three rear side accommodation units 92, together with overlapping with the operating unit 36 and the control device 72 as viewed in plan, are positioned upward of the operating handlebars 44, the operating unit 36, and the control device 72 as viewed from the side. The three rear side accommodation units 92, as viewed in plan, are positioned more on an inner side in the vehicle widthwise direction than both end parts in the vehicle widthwise direction of the auger housing 54.

From among the three rear side accommodation units 92, the rear central accommodation unit 92C is disposed in a central portion of the first left and right support frame 70c that passes through the left-right center line 16. One of the second recognition units 82 is accommodated in the rear central accommodation unit 92C. The second recognition unit 82 that is accommodated in the rear central accommodation unit 92C is a rear center second recognition unit (rearward recognition unit) 82RC. A sensor surface of the rear center second recognition unit 82RC faces rearward. The rear center second recognition unit 82RC recognizes the distance and the direction to the working target object and the surrounding objects that are positioned rearward of the working machine 10.

From among the three rear side accommodation units 92, a rear left accommodation unit 92L is disposed on a left side bracket 74c (refer to FIG. 5). One of the first recognition units 80 is accommodated in the rear left accommodation unit 92L. The first recognition unit 80 that is accommodated in the rear left accommodation unit 92L is a rear left first recognition unit (rearward recognition unit, left recognition unit, rear left recognition unit) 80RL.

The rear left first recognition unit 80RL is accommodated in the rear left accommodation unit 92L, in a manner so as to recognize an area diagonally rearward to the left from the working machine 10. More specifically, the rear left first recognition unit 80RL is positioned in the interior of the rear left accommodation unit 92L, in a manner so that a sensor surface of the rear left first recognition unit 80RL faces diagonally rearward to the left (in a leftward direction and a rearward direction) from the working machine 10. The rear left first recognition unit 80RL recognizes the distance and the direction to the working target object and the surrounding objects that are positioned diagonally rearward to the left from the working machine 10.

From among the three rear side accommodation units 92, a rear right accommodation unit 92R is disposed on a right side bracket 74c. The rear right accommodation unit 92R has a shape obtained by having left-right inverted the front left accommodation unit 92L. One of the first recognition units 80 is accommodated in the rear right accommodation unit 92R. The first recognition unit 80 that is accommodated in the rear right accommodation unit 92R is a rear right first recognition unit (rearward recognition unit, right recognition unit, rear right recognition unit) 80RR.

A rear right first recognition unit 80RR is accommodated in the rear right accommodation unit 92R, in a manner so as to recognize an area diagonally rearward to the right from the working machine 10. More specifically, the rear right first recognition unit 80RR is positioned in the interior of the rear right accommodation unit 92R, in a manner so that a sensor surface of the rear right first recognition unit 80RR faces diagonally rearward to the right (in a rightward direction and a rearward direction) from the working machine 10. The rear right first recognition unit 80RR recognizes the distance and the direction to the working target object and the surrounding objects that are positioned diagonally rearward to the right from the working machine 10.

The two position recognition units 23 are on the two brackets 74b (refer to FIG. 5). The two position recognition units 23 receive signals transmitted from non-illustrated GNSS satellites. The control device 72, based on the signals received by the two position recognition units 23, is capable of identifying the current position of the working machine 10.

As shown in FIG. 1, the plurality of surrounding vicinity recognition units 22 and the plurality of position recognition units 23 are connected to the control device 72 via wiring 100 such as a harness or the like. The wiring 100 is disposed along each of the frames that constitute the frame device 20. Further, the control device 72 is disposed on an outer side of the frame device 20. Specifically, the control device 72 is disposed more downward and rearward than the operating handlebars 44 and the frame device 20.

Further, as shown in FIG. 1, it is desirable that a departure angle θ which, as viewed from the side, is an angle between a straight line connecting a rear end portion of the traveling units 32 and a lower rear end part of the control device 72, and a ground surface of the working machine 10, be greater than or equal to a predetermined angle. In accordance with this feature, it is possible to avoid contact between the control device 72 and the ground surface, in the case that the front part of the working machine 10 rises frontward on a slope or the like, or in the case that the frame side control unit 24 is disposed by being retrofitted on the working machine main body 18.

Next, a description will be given concerning the operation of the working machine 10 according to the present embodiment. In this instance, a description will be given concerning a case in which the working machine 10 travels in a manned manner, and a case in which the working machine 10 travels in an unmanned manner.

First, a description will be given concerning the case in which the working machine 10 travels in a manned manner. The user, by operating the operating unit 36, causes the engine 26 and the electric motors 30 to be started. Next, in a state in which the grips 46 of the operating handlebars 44 are being held, the user causes the working machine 10 to move frontward. In accordance with this feature, the working machine 10, while moving frontward, is capable of carrying out a snow removal operation with respect to the snow that is present frontward thereof.

Specifically, the user, by operating the operating unit 36, causes the working machine 10 to move frontward, to move rearward, or to be stopped. The control device 72, in response to the operations of the operating unit 36 by the user, controls the driving of the electric motors 30, and thereby causes the working machine 10 to move frontward, to move rearward, or to be stopped. Further, the user, by operating the operating unit 36, can cause the engine 26 to be started or to be stopped.

At this time, the two position recognition units 23 are driven by the supply of electrical power from the battery 38, and start receiving signals from the GNSS satellites. The two position recognition units 23 output to the control device 72 the signals that are successively received. The control device 72, based on the signals from the two position recognition units 23, is capable of identifying the current position of the working machine 10.

Further, the plurality of surrounding vicinity recognition units 22 are driven by the supply of electrical power from the battery 38, and successively recognize the distance and the direction to the working target object and the surrounding objects that exist around the vicinity of the working machine 10. The recognition results of the plurality of surrounding vicinity recognition units 22 are sequentially output to the control device 72.

The control device 72, based on the respective recognition results of the plurality of surrounding vicinity recognition units 22, at a time when there is a possibility that the working machine 10 may collide with a surrounding object while the working machine 10 is traveling, is capable of causing the driving of the electric motors 30 to be stopped and is capable of causing the traveling of the working machine 10 to be stopped.

When the snow removal operation in the working region is completed, the user operates the operating unit 36 and thereby causes the traveling and the snow removal operation of the working machine 10 to be stopped. Consequently, the control device 72, based on the operation of the operating unit 36 by the user, stops the supply of electrical power from the battery 38 to each of the respective parts of the working machine 10. As a result, the working machine 10 stops operating.

Next, a description will be given concerning a case in which the working machine 10 travels in an unmanned manner. In the unmanned traveling, a teaching step and a playback step are carried out. In the teaching step, by the above-described manned traveling, a travel route of the working machine 10 in the working region that serves as a target of the snow removal operation is memorized in the working machine 10. In the playback step, in an unmanned state, the working machine 10 carries out the snow removal operation while traveling along the travel route that was memorized in the teaching step. More specifically, in the playback step, the working machine 10 carries out both autonomous traveling and autonomous operation.

First, in the teaching step, the manned traveling is carried out in the working region that serves as the target of the snow removal operation. At this time, the frame side control unit 24 of the control device 72 stores in a non-illustrated memory the route (the travel route) that is traveled by the working machine 10.

Next, in the playback step, the frame side control unit 24, in accordance with the travel route that is stored in the memory, controls the driving of the electric motors 30, and thereby causes the working machine 10 to travel autonomously in the working region. Further, the frame side control unit 24, by controlling the driving of the engine 26, causes the snow removal operation to be carried out autonomously.

In the playback step, the plurality of surrounding vicinity recognition units 22 successively recognize the distance and the direction to the working target object and the surrounding objects that exist around the vicinity of the working machine 10. The frame side control unit 24, based on the recognition results of the plurality of surrounding vicinity recognition units 22, at a time when there is a possibility that the working machine 10 may collide with a surrounding object while the working machine 10 is traveling, causes the driving of the electric motors 30 to be stopped, and causes the traveling of the working machine 10 to be stopped.

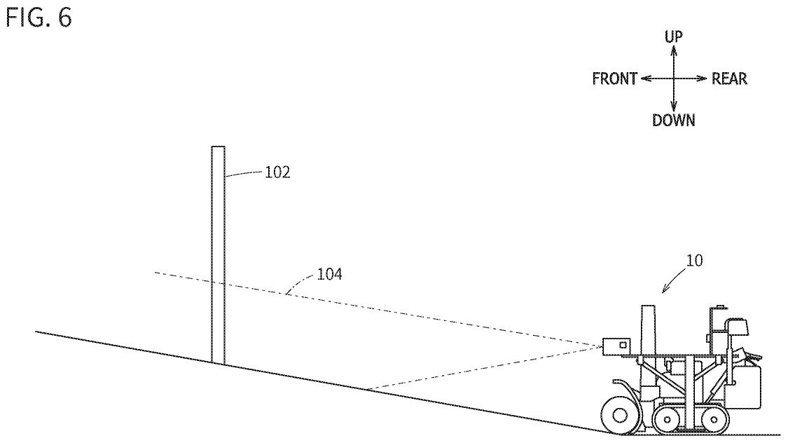

FIG. 6 to FIG. 9 are diagrams showing the recognition range of the surrounding vicinity recognition units 22 (refer to FIG. 1 to FIG. 3). In FIG. 6 to FIG. 9, a detection target 102 (for example, a person or a surrounding object) is present in front of the working machine 10.

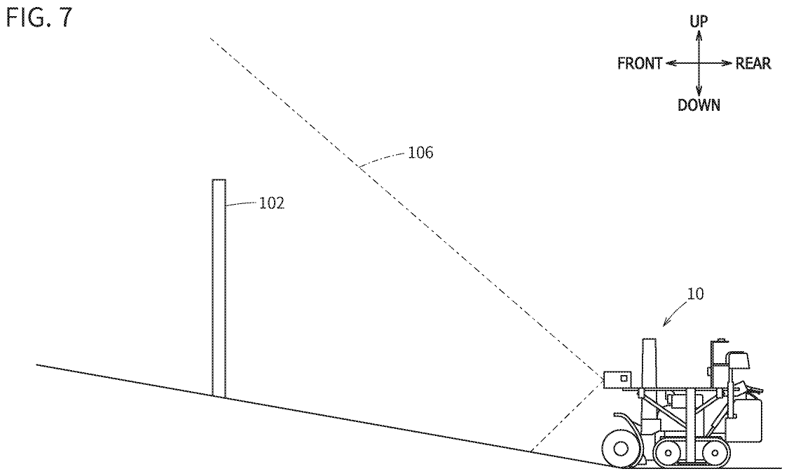

FIG. 6 is a diagram showing a recognition range 104 of the first recognition units 80 (the front left first recognition unit 80FL or the front right first recognition unit 80FR shown in FIG. 2) at a time when the working machine 10 moves frontward on an uphill slope in the frontward direction. FIG. 7 is a diagram showing a recognition range 106 of the second recognition units 82 (the front center second recognition unit 82FC shown in FIG. 2) at a time when the working machine 10 moves frontward on an uphill slope in the frontward direction. More specifically, FIG. 6 and FIG. 7 show the recognition ranges 104 and 106 (the recognition ranges in angles of elevation) at a time when the respective sensor surfaces of the first recognition unit 80 and the second recognition unit 82 face obliquely upward and frontward.

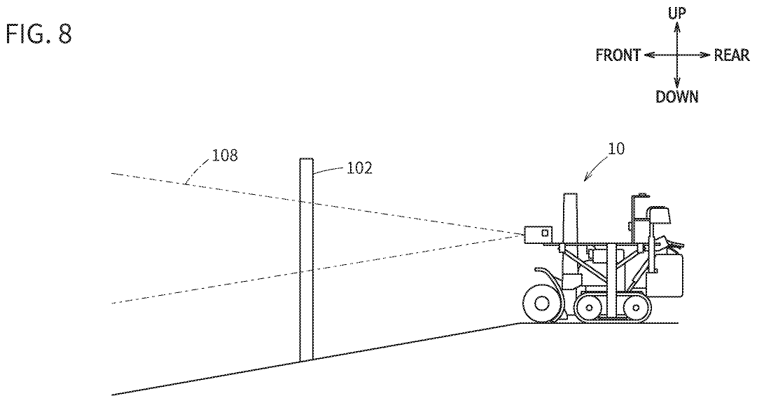

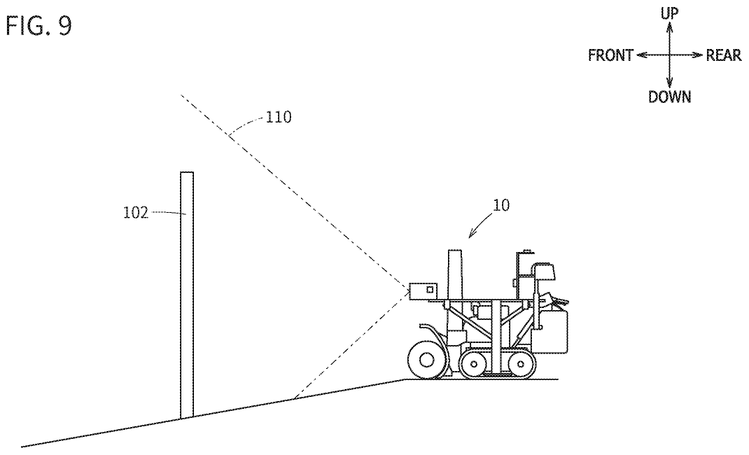

FIG. 8 is a diagram showing a recognition range 108 of the first recognition units 80 (the front left first recognition unit 80FL or the front right first recognition unit 80FR shown in FIG. 2) at a time when the working machine 10 moves frontward on a downhill slope in the frontward direction. FIG. 9 is a diagram showing a recognition range 110 of the second recognition units 82 (the front center second recognition unit 82FC shown in FIG. 2) at a time when the working machine 10 moves frontward on an downhill slope in the frontward direction. More specifically, FIG. 8 and FIG. 9 show the recognition ranges 108 and 110 (the recognition ranges in angles of elevation) at a time when the respective sensor surfaces of the first recognition unit 80 and the second recognition unit 82 face obliquely downward and frontward.

In any of the cases shown in FIG. 6 to FIG. 9, at least a portion of the detection target 102 falls within the recognition ranges 104, 106, 108, and 110 of the first recognition unit 80 and the second recognition unit 82 (refer to FIG. 1 to FIG. 3). Accordingly, in the present embodiment, the detection target 102 can be satisfactorily detected.

The present embodiment is not necessarily limited to the configuration described above.

The working machine 10 may be another working machine that is equipped with a crawler belt. Specifically, as such a working machine, there may be cited various types of construction equipment such as cranes, excavators, bulldozers, and the like.

The working machine 10 may be another working machine that is equipped with vehicle wheels. Specifically, as such a working machine, there may be cited (1) transportation equipment such as transport vehicles, forklifts, and the like, (2) landscaping equipment such as manned or unmanned lawn mowers, robotic lawn mowers, and the like, and (3) agricultural machinery such as tractors, cultivators, combine harvesters, and the like.

The working machine 10 may be a working machine having a ski shaped traveling unit. Specifically, as such a working machine, there may be cited a snowmobile, a snow groomer, or the like. Snowmobiles include ski shaped traveling units (skis or crawlers) and are capable of moving and performing working on snow.

The working machine 10 may be a working machine in which the working unit 28 is driven by the motive power of an electric motor. Alternatively, the working machine 10 may be a hybrid working machine in which the working unit 28 is driven by the motive power of two drive sources including an engine and an electric motor.

The working machine 10 may be a working machine that travels by means of the motive power of an engine. Alternatively, the working machine 10 may be a hybrid working machine that travels by means of the motive power of two drive sources including an engine and an electric motor.

The frame device 20 need only be connected to a portion of the vehicle body frame 34 where the vibrations that are generated at a time when the working machine 10 is in operation are relatively small. Therefore, the frame device 20 may be mounted on the drive shaft portions 50a or the rolling shaft portions 50b. Further, in the case that the working machine 10 is not equipped with crawlers, the frame device 20 may be mounted on am axle portion of the working machine 10.

The surrounding vicinity recognition units 22 need only be capable of recognizing the surrounding vicinity of the working machine 10. Therefore, the surrounding vicinity recognition units 22 may be a camera or a sonar. Further, the position recognition units 23 may recognize the current position of the working machine 10 using an inertial measurement device.

The control device 72, by being equipped with a non-illustrated communication interface, may carry out wireless communication with the exterior of the working machine 10. In this case, by carrying out wireless communication with an external device, in accordance with an instruction from the external device, the control device 72 is capable of carrying out autonomous traveling and autonomous operation of the working machine 10.

The plurality of surrounding vicinity recognition units 22 and the frame side control unit 24 may be mounted directly on the vehicle body frame 34. Alternatively, the plurality of surrounding vicinity recognition units 22 and the frame side control unit 24 may be mounted on the vehicle body frame 34 via non-illustrated stays.

In relation to the above-described embodiment, the following Supplementary Notes are further disclosed.

### Supplementary Note 1

The working machine (10) of the present disclosure is equipped with the vehicle wheels (48), the working unit (28), and the recognition unit (22) that recognizes the surrounding vicinity of the working machine.

In accordance with such a configuration, the situation of the surrounding vicinity of the working machine can be easily recognized. Further, based on the recognition result of the recognition unit, at least one of autonomous traveling and autonomous operation of the working machine becomes possible.

### Supplementary Note 2

In the working machine according to Supplementary Note 1, the recognition unit may be disposed at least one from among frontward with respect to a front-rear center (14), which is the center of the working machine in the front-rear direction, or rearward with respect to the front-rear center.

In accordance with such a configuration, it becomes possible to optimize the disposition of the recognition unit. Further, it is possible to effectively recognize at least one of the frontward and rearward situations. In accordance therewith, it is possible to reduce a blind spot in the region of the recognition target.

### Supplementary Note 3

In the working machine according to Supplementary Note 2, the recognition unit may include the frontward recognition units (80FL, 80FC, 80FR, 82FL, 82FC, 82FR) that are disposed more frontward than the front-rear center, the working unit may be disposed more frontward than the front-rear center, and the frontward recognition unit, as viewed from the side, may be disposed more rearward than the front end part of the working unit.

In accordance with such a configuration, it is possible to recognize the frontward situation without interfering with the operation of the working unit. Further, it is possible to appropriately protect the frontward recognition unit.

### Supplementary Note 4

In the working machine according to Supplementary Note 3, the frontward recognition unit may be positioned more downward than the upper end of the working machine.

In accordance with such a configuration, it is possible to appropriately protect the frontward recognition unit.

### Supplementary Note 5

In the working machine according to Supplementary Note 3 or 4, the frontward recognition unit may overlap with the working unit as viewed in plan but need not necessarily overlap with the operating range of the working unit as viewed from the side.

In accordance with such a configuration, interference between the frontward recognition unit and the working unit can be avoided.

### Supplementary Note 6

In the working machine according to any one of Supplementary Notes 2 to 5, the recognition unit may include at least two frontward recognition units that are disposed more frontward than the front-rear center, and at least one rearward recognition unit (80RL, 80RR, 82RC) that is disposed more rearward than the front-rear center, and the number of the rearward recognition units may be less than the number of the frontward recognition units.

In accordance with such a configuration, since the number of the frontward recognition units is greater than the number of the rearward recognition units, the frontward situation can be recognized with high accuracy. In accordance with this feature, it is possible to accurately detect obstacles and the like present ahead.

### Supplementary Note 7

In the working machine according to any one of Supplementary Notes 2 to 6, the recognition unit may include the frontward recognition unit that is disposed more frontward than the front-rear center, and the rearward recognition unit that is disposed more rearward than the front-rear center, and the rearward recognition unit may be disposed more upward than the frontward recognition unit.

In accordance with such a configuration, rearward of the working machine, a larger space can serve as the recognition range.

### Supplementary Note 8

In the working machine according to Supplementary Note 6 or 7, there may further be provided the control unit (72) disposed more rearward than the front-rear center and configured to control the working unit, wherein the rearward recognition unit may be disposed more downward than the upper end of the working machine and more upward than the control unit.

In accordance with such a configuration, the rearward recognition unit can be disposed and protected in an appropriate position.

### Supplementary Note 9

In the working machine according to any one of Supplementary Notes 1 to 8, the recognition unit may be disposed more on the inner side in the left-right direction than both end parts in the left-right direction of the working machine.

In accordance with such a configuration, since the recognition unit does not project out in the left-right direction from the working machine, the recognition unit can be appropriately protected.

### Supplementary Note 10

In the working machine according to Supplementary Note 9, the recognition unit may be disposed more on the inner side in the left-right direction than both end parts in the left-right direction of the working unit.

In accordance with such a configuration, since the recognition unit does not project out in the left-right direction from the working unit, the recognition unit can be appropriately protected from the working target of the working unit.

### Supplementary Note 11

In the working machine according to Supplementary Note 10, the recognition unit may be positioned more closely to the left-right center line (16) that passes through the left-right center, which is the center in the left-right direction of the working machine, and extends in the front-rear direction of the working machine, than both end parts in the left-right direction of the working machine.

In accordance with such a configuration, it is possible to more appropriately protect the recognition unit.

### Supplementary Note 12

In the working machine according to any one of Supplementary Notes 1 to 11, the recognition unit may include the left side recognition units (80FL, 80RL, 82FL) disposed more on the left side than the left-right center line that passes through the left-right center, which is the center in the left-right direction of the working machine, and extends in the front-rear direction of the working machine, and the right side recognition units (80FR, 80RR, 82FR) that are disposed more on the right side than the left-right center line.

In accordance with such a configuration, it is possible to effectively recognize the condition more on the left side and the condition more on the right side than the working machine.

### Supplementary Note 13

In the working machine according to Supplementary Note 12, the left side recognition unit may include the front left recognition units (80FL, 82FL) that are disposed more frontward than the front-rear center, which is the center in the front-rear direction, and the rear left recognition unit (80RL) that is disposed more rearward than the front-rear center, and the right side recognition unit may include the front right recognition units (80FR, 82FR) that are disposed more frontward than the front-rear center, and the rear right recognition unit (80RR) that is disposed more rearward than the front-rear center.

In accordance with such a configuration, it is possible to more effectively recognize the condition on the front and rear and the left and right of the working machine.

### Supplementary Note 14

In the working machine according to Supplementary Note 13, the front left recognition unit and the front right recognition unit may be disposed more rearward than the front end part of the working unit and may overlap with the working unit as viewed in plan and need not necessarily overlap with the operating range of the working unit as viewed from the side.

In accordance with such a configuration, it is possible to recognize the situation on both of the frontward left and right sides without interfering with the operation of the working unit. Further, the front left recognition unit and the front right recognition unit can be appropriately protected. Furthermore, it is possible to avoid interference between the front left recognition unit and the front right recognition unit and the working unit.

### Supplementary Note 15

In the working machine according to Supplementary Note 13 or 14, there may further be provided the control unit disposed more rearward than the front-rear center, and configured to control the working unit, wherein the rear left recognition unit and the rear right recognition unit may be disposed more downward than the upper end of the working machine and more upward than the control unit.

In accordance with such a configuration, the rear left recognition unit and the rear right recognition unit can be disposed and protected in appropriate positions.

### Supplementary Note 16

In the working machine according to any one of Supplementary Notes 1 to 15, the recognition unit may include the first recognition unit (80) that serves to recognize the surrounding vicinity of the working machine by means of the first recognition mechanism, and the second recognition unit (82) that serves to recognize the surrounding vicinity of the working machine by means of the second recognition mechanism that differs from the first recognition mechanism.

In accordance with such a configuration, the situation of the surrounding vicinity of the working machine can be recognized effectively based on the recognition mechanisms that differ from each other.

### Supplementary Note 17

In the working machine according to Supplementary Note 16, the second recognition unit may have a wider recognition range than the first recognition unit, may have a higher distance measurement capacity than the first recognition unit, or may have both a wider recognition range and a higher distance measurement capacity than the first recognition unit.

In accordance with such a configuration, concerning the second front part recognition unit, the distance measurement capacity thereof can be improved with respect to a larger space.

### Supplementary Note 18

In the working machine according to any one of Supplementary Notes 1 to 17, there may further be provided the position recognition unit (23) that serves to recognize the position of the working machine.

In accordance with such a configuration, it becomes possible to identify the current position of the working machine.

### Supplementary Note 19

In the working machine according to Supplementary Note 18, the position recognition unit may be disposed at a position that is lower than the upper end of the working machine.

In accordance with such a configuration, it is possible to appropriately protect the position recognition unit.

### Supplementary Note 20

In the working machine according to Supplementary Note 18 or 19, the position recognition unit may be disposed more rearward than the working unit and more frontward than the rear end of the working machine.

In accordance with such a configuration, it is possible to more appropriately protect the position recognition unit.

### Supplementary Note 21

In the working machine according to any one of Supplementary Notes 18 to 20, the position recognition unit may be disposed more on the inner side in the left-right direction than both end parts in the left-right direction of the working machine.

In accordance with such a configuration, since the position recognition unit does not project out in the left-right direction from the working machine, the position recognition unit can be appropriately protected.

### Supplementary Note 22

In the working machine according to any one of Supplementary Notes 1 to 21, there may further be provided the mounting frame (20) on which the recognition unit is mounted.

In accordance with such a configuration, the recognition unit can be easily mounted on the working machine.

### Supplementary Note 23

In the working machine according to Supplementary Note 22, there may further be provided the vehicle body frame (34) configured to rotatably support the vehicle wheels and operably support the working unit, wherein the mounting frame may be mounted on the vehicle body frame.

In accordance with such a configuration, by mounting the mounting frame on the vehicle body frame the rigidity of which is relatively high, it is possible to appropriately support the recognition unit with respect to the working machine. Further, even in the case that the vehicle wheels are rotating and the working unit is operating, vibrations that are transmitted to the vehicle body frame are relatively small. By mounting the mounting frame on the vehicle body frame, vibrations that are transmitted to the recognition unit are suppressed, and noise in relation to the recognition result of the recognition unit can be reduced.

### Supplementary Note 24

In the working machine according to Supplementary Note 23, the mounting frame may be attachable and detachable with respect to the vehicle body frame.

In accordance with such a configuration, the recognition unit can be easily installed in an existing working machine.

### Supplementary Note 25

In the working machine according to any one of Supplementary Notes 22 to 24, there may further be provided the control unit that serves to control the working unit, and the wiring (100) that electrically connects the recognition unit and the control unit, wherein the wiring may be disposed along the mounting frame.

In accordance with such a configuration, the wiring can be appropriately protected.

### Supplementary Note 26

In the working machine according to Supplementary Note 25, the control unit may be disposed more rearward than the front-rear center, which is the center in the front-rear direction of the working machine.

In accordance with such a configuration, it becomes possible to appropriately dispose the control unit.

### Supplementary Note 27

In the working machine according to Supplementary Note 25 or 26, the control unit may be mounted on the mounting frame.

In accordance with such a configuration, the control unit can be easily installed in an existing working machine.

### Supplementary Note 28

In the working machine according to any one of Supplementary Notes 25 to 27, there may further be provided the operating unit (36) configured to be operated by the user of the working machine, wherein the control unit may be disposed downward of the operating unit.

In accordance with such a configuration, the control unit can be disposed without interfering with the operation of the operating unit by the user.

### Supplementary Note 29

In the working machine according to Supplementary Note 28, the recognition unit may be disposed more frontward than the rear end of the operating unit.

In accordance with such a configuration, the recognition unit can be disposed without interfering with the operation of the operating unit by the user.

### Supplementary Note 30

In the working machine according to any one of Supplementary Notes 25 to 29, the control unit may be disposed on the outer side of the mounting frame.

In accordance with such a configuration, the control unit can be easily mounted on and taken off from the working machine. In accordance with this feature, it becomes easier to perform maintenance on the control unit.

Although concerning the present disclosure, a detailed description thereof has been presented above, the present disclosure is not necessarily limited to the individual embodiments described above. These embodiments may be subjected to various additions, substitutions, modifications, partial deletions and the like, within a range that does not deviate from the essence and gist of the present disclosure, or the spirit of the present disclosure as derived from the content described in the claims and equivalents thereof. Further, the embodiments can also be implemented together in combination. For example, in the above-described embodiments, the order of each of the operations and the order of each of the processes are illustrated as examples, and the present invention is not necessarily limited to these features. The same also applies to cases in which numerical values or mathematical expressions are used in the description of the aforementioned embodiments.

What is claimed is:

1. A working machine, comprising:
vehicle wheels;
a working unit; and
a recognition unit configured to recognize a surrounding vicinity of the working machine.

2. The working machine according to claim 1, wherein the recognition unit is disposed at least one from among frontward with respect to a front-rear center, which is a center of the working machine in a front-rear direction, or rearward with respect to the front-rear center.

3. The working machine according to claim 2, wherein:
the recognition unit includes a frontward recognition unit disposed more frontward than the front-rear center;
the working unit is disposed more frontward than the front-rear center; and
the frontward recognition unit, as viewed from a side, is disposed more rearward than a front end part of the working unit.

4. The working machine according to claim 3, wherein the frontward recognition unit is positioned more downward than an upper end of the working machine.

5. The working machine according to claim 3, wherein the frontward recognition unit overlaps with the working unit as viewed in plan and does not overlap with an operating range of the working unit as viewed from the side.

6. The working machine according to claim 2, wherein:
the recognition unit comprises at least two frontward recognition units disposed more frontward than the front-rear center, and at least one rear rearward recognition unit disposed more rearward than the front-rear center; and
the number of the rearward recognition units is less than the number of the frontward recognition units.

7. The working machine according to claim 2, wherein:
the recognition unit includes a frontward recognition unit disposed more frontward than the front-rear center, and a rearward recognition unit disposed more rearward than the front-rear center; and
the rearward recognition unit is disposed more upward than the frontward recognition unit.

8. The working machine according to claim 6, further comprising a control unit disposed more rearward than the front-rear center and configured to control the working unit;
wherein the rearward recognition unit is disposed more downward than an upper end of the working machine and more upward than the control unit.

9. The working machine according to claim 1, wherein the recognition unit is disposed more on an inner side in the left-right direction than both end parts in the left-right direction of the working machine.

10. The working machine according to claim 9, wherein the recognition unit is disposed more on an inner side in the left-right direction than both end parts in the left-right direction of the working unit.

11. The working machine according to claim 10, wherein the recognition unit is positioned more closely to a left-right center line that passes through a left-right center, which is a center in the left-right direction of the working machine, and extends in the front-rear direction of the working machine, than the both end parts in the left-right direction of the working machine.

12. The working machine according to claim 1, wherein the recognition unit comprises:
a left side recognition unit disposed more on a left side than a left-right center line that passes through a left-right center, which is a center in the left-right direction of the working machine, and extends in the front-rear direction of the working machine; and
a right side recognition unit disposed more on a right side than the left-right center line.

13. The working machine according to claim 12, wherein:
the left side recognition unit includes a front left recognition unit disposed more frontward than a front-rear center, which is a center in the front-rear direction, and a rear left recognition unit disposed more rearward than the front-rear center;
the right side recognition unit includes a front right recognition unit disposed more frontward than the front-rear center, and a rear right recognition unit disposed more rearward than the front-rear center.

14. The working machine according to claim 13, wherein the front left recognition unit and the front right recognition unit are disposed more rearward than a front end part of the working unit and overlap with the working unit as viewed in plan, and do not overlap with an operating range of the working unit as viewed from a side.

15. The working machine according to claim 13, further comprising a control unit disposed more rearward than the front-rear center and configured to control the working unit;
wherein the rear left recognition unit and the rear right recognition unit are disposed more downward than an upper end of the working machine and more upward than the control unit.

16. The working machine according to claim 1, wherein the recognition unit includes:
a first recognition unit configured to recognize a surrounding vicinity of the working machine by means of a first recognition mechanism; and
a second recognition unit configured to recognize a surrounding vicinity of the working machine by means of a second recognition mechanism that differs from the first recognition mechanism.

17. The working machine according to claim 16, wherein the second recognition unit has a wider recognition range than the first recognition unit, has a higher distance measurement capacity than the first recognition unit, or has both a wider recognition range and a higher distance measurement capacity than the first recognition unit.

18. The working machine according to claim 1, further comprising a position recognition unit configured to recognize a position of the working machine.

19. The working machine according to claim 18, wherein the position recognition unit is allowed to be disposed at a position that is lower than an upper end of the working machine.

20. The working machine according to claim 18, wherein the position recognition unit is disposed more rearward than the working unit and more frontward than a rear end of the working machine.

21. The working machine according to claim 18, wherein the position recognition unit is disposed more on an inner side in the left-right direction than both end parts in the left-right direction of the working machine.

22. The working machine according to claim 1, further comprising a mounting frame on which the recognition unit is mounted.

23. The working machine according to claim 22, further comprising
a vehicle body frame configured to rotatably support the vehicle wheels and operably support the working unit,
wherein the mounting frame is mounted on the vehicle body frame.

24. The working machine according to claim 23, wherein the mounting frame is attachable and detachable with respect to the vehicle body frame.

25. The working machine according to claim 22, further comprising:
a control unit configured to control the working unit; and
a wiring configured to electrically connect the recognition unit and the control unit,
wherein the wiring is disposed along the mounting frame.

26. The working machine according to claim 25, wherein the control unit is disposed more rearward than a front-rear center, which is a center in a front-rear direction of the working machine.

27. The working machine according to claim 25, wherein the control unit is mounted on the mounting frame.

28. The working machine according to claim 25, further comprising
an operating unit configured to be operated by a user of the working machine,
wherein the control unit is disposed downward of the operating unit.

29. The working machine according to claim 28, wherein the recognition unit is disposed more frontward than a rear end of the operating unit.

30. The working machine according to claim 25, wherein the control unit is disposed on an outer side of the mounting frame.
